(19) United States
(12) Patent Application Publication
(10) Pub. No.: US 2011/0082222 A1
(43) Pub. Date: Apr. 7, 2011

(54) USE OF A MATERIAL IMPARTING PROTON CONDUCTIVITY IN THE PRODUCTION OF FUEL CELLS

(75) Inventors: Torsten Ziser, Weinheim (DE); Thomas Früh, Mutterstadt (DE); Domnik Bayer, Heidelberg (DE); Dieter Melzner, Gottingen (DE); Annette Reiche, Gottingen (DE)

(73) Assignees: Elcomax GmbH, Munich (DE); Rhein Chemie Rheinau GmbH, Mannheim (DE)

(21) Appl. No.: 12/967,536

(22) Filed: Dec. 14, 2010

Related U.S. Application Data
(63) Continuation of application No. PCT/EP2009/057467, filed on Jun. 16, 2009.

(30) Foreign Application Priority Data
Jun. 16, 2008 (DE) 10 2008 002 457.0

(51) Int. Cl. C08J 5/20; B01J 41/12

(52) U.S. Cl. 521/38; 521/25; 521/30

(57) ABSTRACT

The invention relates to the use of a material imparting proton conductivity in the production of fuel cells, said material consisting of monomer units and having an irregular shape.

### CROSS REFERENCE TO RELATED APPLICATIONS

This application is a continuation of PCT/EP2009/057467, filed on Jun. 16, 2009, which claims priority to DE Application No. 10 2008 002 457.0, filed on Jun. 16, 2008, the contents of each being incorporated herein by reference.

### FIELD OF THE INVENTION

The present invention relates to the use of a material imparting proton conductivity in the production of fuel cells.

### BACKGROUND OF THE INVENTION

From DE 102007011427 it is known that polymer particles produced by emulsion polymerization, having a mean particle diameter of 5 to 500 mm and containing ionogenic groups can be used as proton-donating and/or proton-accepting substance in heterogeneous chemical processes. Because of the nature of their production, the polymer particles obtained from the latex of the emulsion polymerization have regular spherical geometry.

The spectrum of properties exhibited by these materials known from DE 102007011427 could be further improved. In particular, the properties of the materials need improvement as regards the relatively high gel content, since less densely cross-linked systems, or in other words systems with a larger-meshed network in the polymer structure, may be better suited for certain applications, for example as additive in materials for fuel-cell production. Further room for improvements also exists with regard to modifying the mechanical characteristics of polymer materials into which the polymer particles are incorporated.

From DE 102007011424 (WO2008107192A1) there are known polymer electrolyte membranes composed of a polymer matrix of at least one basic polymer and one or more doping agents, wherein particles containing ionogenic groups and having a mean particle diameter in the nanometer range are embedded in the polymer matrix and the particles containing ionogenic groups are distributed homogeneously in the polymer matrix in a concentration of less than 50% relative to the weight of the polymer matrix. This polymer matrix produced by means of emulsion polymerization also still does not have the optimal properties profile.

A fuel cell is a galvanic cell that converts the chemical reaction energy of a continuously supplied fuel and oxidizing agent into electrical energy. At present, the production of electrical energy from chemical energy carriers is achieved mostly indirectly via thermal and motion energy by using a heat engine in conjunction with a generator. The fuel cell is suitable for achieving the transformation directly and thus is potentially more efficient.

The fuel cell is composed of electrodes separated from one another by a membrane or by an electrolyte (ion conductor). Besides the electrodes, therefore, the electrolyte constitutes an important part of an electrochemical cell. It should be electrically insulated, since in addition to its function as proton conductor it simultaneously acts as a separator for the two electrode compartments, and it should also be thermally and mechanically stable. Whereas liquid electrolytes were frequently used in the past, there is now a growing trend toward solid electrolytes, for reasons of orientation, independence and stability of the cells. In this context the definition of solid ranges from gelatinous or rubbery to ceramic.

The phosphoric acid fuel cell differs from other fuel cells by the fact that it works with phosphoric acid as the electrolyte. The highly concentrated phosphoric acid, which is used in concentrations of 90 to 100%, is frequently fixed in a PTFE phase structure. The gas used as fuel in the phosphoric acid fuel cell is hydrogen, while air or pure oxygen may be used as the oxidizing agent.

The polymer electrolyte fuel cell is a low-temperature fuel cell, which converts chemical and electrical energy using hydrogen and oxygen. Depending on working point, the electrical efficiency is approximately 60%. Normally a solid polymer membrane, for example of Nafion® (based on polymers containing perfluorinated sulfonic acid groups), is used as electrolyte therein.

The membranes are coated on both sides with a catalytically active electrode, frequently a mixture of carbon (carbon black) and a catalyst, frequently platinum or a mixture of platinum with ruthenium (PtRu electrodes), platinum with nickel (PtNi electrodes) or platinum with cobalt (PtCo electrodes). Hydrogen molecules dissociate on the anode side and are each oxidized to two protons, in the process releasing two electrons. These protons diffuse through the membrane. On the cathode side, oxygen is reduced by the electrons, which previously were able to perform electrical work; together with the protons transported through the electrolyte, water is formed. In order to be able to use the electrical work, anode and cathode are connected to an electrical load.

Because charge transport in these membranes is contingent on the presence of water, however, the operating range of corresponding polymer electrolyte membrane fuel cells is limited to a maximum of 100° C. In order to achieve a higher operating temperature, membranes provided with inorganic particles have been proposed for fuel cells (see DE 19919988 A1, DE 10205849 A1, WO 03/063266 A2 and WO 03/081691 A2).

DE 102004009396 A1 describes membranes for fuel cells with improved electrical, mechanical and thermal properties in fuel-cell operation. These membranes are composed of a polymer, particularly preferably a plastic, a natural substance, silicone or rubber, and of a proton-conducting substance. However, such membranes do not exhibit any industrially significant conductivities at room temperature and have poor mechanical stability.

The membranes used in these fuel cells are therefore still in need of improvement. In particular, the membrane properties in general and especially as regards conductivity, mechanical and thermal stability, swelling and compatibility with the electrodes being used are in need of improvement. These membrane properties may be improved in general by means of additives. For this purpose, however, no polymer additives with an appropriate properties profile have yet been available.

### SUMMARY

Accordingly, the object of the present invention is to provide additives that impart proton conductivity, that—for example, compared with the materials known from DE 102007011427—have a lesser degree of branching and can be used, for example, in membranes employed in particular in phosphoric acid fuel cells and polymer electrolyte fuel cells.

In particular, it is an object of the present invention to provide, for membranes in phosphoric acid fuel cells or polymer electrolyte fuel cells, additives that improve the conductivity.

A further object of the present invention is to provide, for membranes in phosphoric acid fuel cells or polymer electrolyte fuel cells, additives that improve the mechanical and thermal stability of the membrane.

A further object of the present invention is especially to provide, for membranes in phosphoric acid fuel cells or polymer electrolyte fuel cells, additives that have good swelling behavior.

The additives used for these purposes should preferably have good compatibility, meaning in particular miscibility, with the respective membrane materials.

If possible, the additives provided according to the invention should contain a high proportion of acid-modified or base-modified monomers and high transparency, and should have good compatibility with the membrane.

Furthermore, it was desired to endow electrode materials for fuel cells as well as for gas-diffusion electrodes for high-temperature polymer electrolyte fuel cells with improved power density and long-term stability, wherein the catalyst layer exhibits good adherence and proton-conducting bonding on a gas-diffusion layer and/or a polymer electrolyte membrane as well as durably high stability under operating conditions above 100° C. Further objects of the invention are then to provide methods for effective production of such gas-diffusion electrodes and fuel cells for operating temperatures up to 200° C. or even up to 250° C. using these gas-diffusion electrodes.

The objects described in the foregoing are achieved by the new application of a material imparting proton conductivity, which material is formed from monomer units and has an irregular form.

The subject matter of the invention is in particular the use of a polymeric material imparting proton conductivity, wherein the polymeric material is preferably formed from acid-modified and/or base-modified monomer units and has an irregular form.

Within the scope of the present invention, the phrase “material imparting proton conductivity” means a material that can act as a proton acceptor and/or proton donor and thus permits in particular delocalization and/or transport of protons. In general, this is contingent upon the presence of acid and/or basic functional groups that can release protons, for example acid groups, such as carboxyl groups, sulfonic acid groups, etc., or that can absorb protons, for example basic groups, especially such as amino groups. Materials modified with acid groups and imparting proton conductivity therefore exhibit base-accepting properties, whereas materials modified with basic groups and imparting proton conductivity exhibit especially acid-accepting properties.

The materials imparting proton conductivity and used according to the invention are generally also proton-conducting themselves, and so, as a particular example, they permit the production of membranes that allow conduction of protons through the membrane. This can be demonstrated, for example, by conductivity and resistivity measurements, etc.

Within the scope of the present invention, an irregular form is to be understood as any form of particles that is not approximately spherical. An “approximately spherical” geometry means that the particles substantially form a circular surface when viewed, for example in an electron microscope. In particular, the materials used according to the invention, and generally supplied in the form of dry powder, exhibit corners or jagged shapes caused by size-reduction and grinding processes. An example of the corners and edges of the inventive particles is illustrated in FIG. 1. What is shown in FIG. 1 is a photograph of sample 3 (DB 43) of the Examples taken under an optical microscope. Thereby the inventive materials are distinguished in particular from polymers produced by emulsion polymerization, since these generally have approximately spherical geometry because of the nature of their production (micelles).

### BRIEF DESCRIPTION OF THE DRAWINGS

FIG. 1 is a photograph of sample 3 (DB 43) of the Examples taken under an optical microscope.

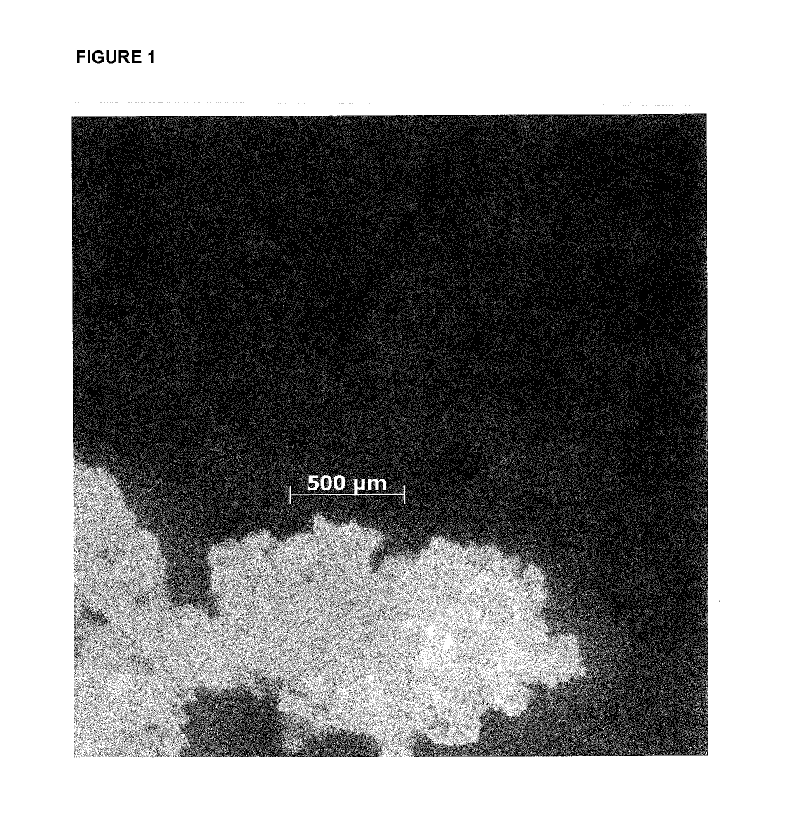

### DETAILED DESCRIPTION

According to the invention, it has been found that the polymeric materials imparting proton conductivity and used according to the invention, and in general being cross-linked in broad-meshed but three-dimensional manner, improve the properties profile of membranes and gas-diffusion electrodes for fuel cells.

Furthermore, the materials imparting proton conductivity and used according to the invention exhibit good compatibility with the matrix materials of membranes used in phosphoric acid fuel cells and polymer electrolyte fuel cells, and they exhibit good compatibility with the matrix materials of catalyst layers of gas-diffusion electrodes for polymer electrolyte fuel cells having an operating temperature up to 250° C.

With the materials imparting proton conductivity according to the invention, there are provided in particular additives that retain their activity in concentrated phosphoric acid and at high temperatures above 120° C. during operation.

In a preferred embodiment of the present invention, the polymeric material imparting proton conductivity is cross-linked with a cross-linking agent.

The polymer matrix in phosphoric acid fuel cells is frequently formed by polybenzimidazole (PBI, poly-[2,2′-(m-phenylene)-5,5′-dibenzimidazole]). With a glass transition temperature of 425° C. and long-term thermal stability of up to 310° C., PBI is suitable for use in this temperature region. Furthermore, the material is electrically insulating, which is a basic prerequisite for use as membrane material in a fuel cell. However, PBI is thermoplastic and not flexible. Consequently it suffers from disadvantages for handleability of the membranes, for example during the production process (high rejects rate) and during operation (possibility of failure due to vibrations). According to the invention, it has now been discovered that, in contrast to polybenzimidazole, the inventive materials imparting proton conductivity contain polymer chains that are flexible at operating temperature and do not have an excessive degree of cross linking. This leads to an improvement of this situation. Therefore the inventive materials imparting proton conductivity and exhibiting the aforesaid degree of cross linking are preferred.

The inventive material imparting proton conductivity preferably contains monomer units based on at least one compound selected from the group consisting of styrene, ethylene glycol methacrylate phosphate (MAEP), vinylsulfonic acid (VSS), styrenesulfonic acid (SSS), vinylphosphonic acid (VPS), N-vinylimidazole (VID), 4-vinylpyridine (VP), N-[3-(dimethylamino)propyl]methacrylamide (DMAPMA), (dimethylamino)ethyl methacrylate (DMAEMA), acrylamide, 2-acrylamidoglycolic acid, 2-acrylamido-2-methyl-1-propanesulfonic acid, acrylic acid [2-(((butylamino)-carbonyl)-oxy)ethyl ester], acrylic acid (2-diethylaminoethyl ester), acrylic acid (2-dimethylamino)-ethyl ester), acrylic acid (3-dimethylamino)-propyl ester), acrylic acid isopropylamide, acrylic acid phenylamide, acrylic acid (3-sulfopropyl ester) potassium salt, methacrylic acid amide, methacrylic acid 2-aminoethyl ester hydrochloride, methacrylic acid (2-(tert-butylamino)-ethyl ester), methacrylic acid ((2-dimethylamino)-methyl ester), methacrylic acid (3-dimethylaminopropylamide), methacrylic acid isopropylamide, methacrylic acid (3-sulfopropyl ester) potassium salt, 3-vinylaniline, 4-vinylaniline, N-vinylcaprolactam, N-vinylformamide, 1-vinylimidazole, 2-vinylpyridine, 4-vinylpyridine, 1-vinyl-2-pyrrolidone, 5-vinyluracil, methacrylic acid glycidyl ester (GDMA), mixtures of the aforesaid compounds, salts of the aforesaid compounds and the conjugate acids or bases of the aforesaid compounds. If the compounds exist as salts, they may be converted to the neutral organic monomers if necessary before polymerization.

In one embodiment of the invention, the proportion by weight of these monofunctional monomers during production of the inventive materials, expressed as 100 parts by weight, especially as 100 wt % of all monomers (including the cross-linking monomers), is generally 0.1 to 100 wt %, particularly preferably 10 to 99.0 wt %, especially 30 to 98 wt %, the other monomers generally being polyfunctional monomers, such as mentioned hereinafter.

In another preferred embodiment of the invention, the proportion by weight of these monofunctional monomers, expressed as 100 parts by weight (especially as 100 wt %) of all monomers (including the cross-linking monomers), is 40 to 100 wt %, particularly preferably 50 to 99.0 wt %, most particularly preferably >50 to 98 wt %, the other monomers generally being polyfunctional monomers, such as mentioned hereinafter.

The inventive material preferably has a swelling index of 0.5 to 50, especially 3 to 45, particularly preferably 3 to 35, most particularly preferably 3 to 25. The swelling index is determined as described in the Example section.

The inventive materials imparting proton conductivity preferably contain ionogenic groups. According to the invention, ionogenic groups are groups that are ionic or capable of forming ionic groups. In this way they are capable of being proton-donating and/or proton-accepting. Preferably the ionogenic groups are acid or basic groups introduced via monomers containing basic and/or acid functional groups. Particularly preferably, the inventive material contains basic groups.

In a preferred embodiment of the present invention, the polymeric material imparting proton conductivity consists of monofunctional monomer units, which are modified by basic and/or acid groups, and possibly of polyfunctional monomer units (cross-linking agents).

In a preferred embodiment of the present invention, the polymeric material is cross-linked with a cross-linking agent.

In a preferred embodiment of the present invention, the polymeric material contains monomer units containing basic and/or acid groups.

In a preferred embodiment of the present invention, the polymeric material consists of monofunctional monomer units modified by basic and/or acid groups, and possibly of polyfunctional monomer units (cross-linking agents).

In a preferred embodiment of the present invention, the polymeric material is cross-linked with a neutral or basic cross-linking agent.

In a preferred embodiment of the present invention, the ionogenic groups, especially the proton-donating and/or proton-accepting groups, are selected from one or more of the following acid functional groups: —COOH, —SO₃H, —OSO₃H, —P(O)(OH)₂, —O—P(OH)₂ and —O—P(O)(OH)₂ and/or salts thereof and/or derivatives thereof, especially partial esters thereof. The salts represent the conjugate bases to the acid functional groups, or in other words —COO⁻, —SO₃⁻, —OSO₃⁻, —P(O)₂(OH)⁻ or —P(O)₃³⁻, —O—P(O)₂²⁻ and —OP(O)₂(OH)⁻ or —OP(O)₃²⁻ in the form of their metal salts, preferably alkali metal or ammonium salts, particularly preferably sodium or potassium salts.

In a further preferred embodiment of the present invention, the ionogenic groups, especially the proton-donating and/or proton-accepting groups, are selected from one or more of the following basic functional groups: —NR₂, wherein R is selected from hydrogen, alkyl or aryl. Preferably R is hydrogen and/or alkyl with 1 to 18, preferably 1 to 10, more preferably 1 to 6 carbon atoms. Particularly preferably —NR₂ is dialkylamino, especially such as dimethylamino. The basic groups may also exist in the form of their acid addition salts, especially such as hydrochlorides. The conjugate bases of the aforesaid acid functional groups may also be used as basic groups, for example a carboxylate group, such as —COONa.

According to the invention, particularly preferred ionogenic groups within the meaning of the invention are selected from —SO₃H, —PO(OH)₂, —O—P(OH)₂ and/or salts thereof and/or derivatives thereof, especially such as partial esters thereof, as well as particularly preferably from the —NR₂ basic groups and the acid addition salts thereof as defined in the foregoing.

The advantage of using basic functional groups or monomers containing such groups consists, for example, in the fact in particular that the swelling of polymers in which the corresponding inventive materials are incorporated is improved in acid media.

By virtue of the modification of the inventive materials containing the ionogenic groups, it is possible that the inventive materials imparting proton conductivity exert the utmost attractive effect, for example on the phosphoric acid. Within the scope of the invention, the property “attractive” is understood as reinforcement of charge transport by the inventive material. Therefore a basic or acid modification is preferred. In this respect it is particularly preferred that the polymer be modified by basic groups.

The material of the present invention imparting proton conductivity may be cross-linked with a neutral or basic cross-linking agent. The inventive material may also be provided with basic groups by cross-linking the foregoing monomers with a basic cross-linking agent. As an example, the basic cross-linking agent may be triallylamine.

Particularly preferably, the inventive materials are cross-linked materials. They are produced in general by radical polymerization, in solution or in bulk, of monomers capable of undergoing radical polymerization, the polymerization being started with standard radical starters.

Cross-linking of the polymeric material is generally achieved by at least one of the following measures:
a) by copolymerization with multifunctional compounds having cross-linking action (referred to as cross-linking agents),
b) by subsequent cross-linking, after polymerization, using cross-linking agents or vulcanization agents or by high-energy radiation, for example with light of wavelength shorter than 600 nm, preferably shorter than 400 nm,
c) by continuing the polymerization to high conversions, such as at least approximately 80 mol % relative to the total amount of all monomers,
d) in the monomer-feed method, by polymerization with high internal conversions, such as at least approximately 80 mol % relative to the total amount of the already fed monomers.

Cross-linking of the polymeric material is also achieved in particular by at least one of the following measures:
a) by copolymerization in the melt or in solution with multifunctional compounds having cross-linking action (cross-linking agents),
b) by subsequent cross-linking, after polymerization, using cross-linking agents or by high-energy radiation,
c) by continuing the polymerization in the melt or in solution to high conversions,
d) in the monomer-feed method, by polymerization in the melt or in solution with high internal conversions,
   then subjecting the polymeric material to at least one size-reduction process after cross-linking.

Polymerization in the melt or in solution is a method known in the prior art.

In this connection, direct cross-linking during polymerization with multifunctional compounds having cross-linking action (cross-linking agents) is the preferred cross-linking method.

Particularly suitable as cross-linking agents are compounds selected from the group consisting of multifunctional monomers having at least two, preferably 2 to 4 copolymerizable C═C double bonds, such as preferably diisopropenylbenzene, divinyl benzene, trivinylbenzene, divinyl ether, divinyl sulfone, diallyl phthalate, triallyl cyanurate, triallyl isocyanurate, 1,2-polybutadiene, N,N′-m-phenylene maleimide, 2,4-toluoylenebis(maleimide) and/or triallyl trimellitate, acrylates and methacrylates of polyhydric, preferably dihydric to tetrahydric C2 to C10 alcohols, such as preferably ethylene glycol, propanediol-1,2, butanediol, hexanediol, polyethylene glycol with 2 to 20, preferably 2 to 8 oxyethylene units, neopentyl glycol, bisphenol A, glycerol, trimethylolpropane, pentaerythritol and sorbitol, such as preferably trimethylolpropane trimethacrylate (TMPTMA), dimethylene glycol dimethacrylate (EGDMA), unsaturated polyesters of aliphatic diols and polyols and maleic acid, fumaric acid and/or itaconic acid, and polyallylamines, such as triallylamine.

According to the invention, particularly preferred as cross-linking agents are: acrylates and methacrylates of polyhydric alcohols, preferably dihydric to tetrahydric C2 to C10 alcohols, such as mostly preferred: trimethylolpropane trimethacrylate (TMPTMA).

Within the scope of the present invention it is preferred that the proportion by weight of cross-linking agents relative to the total amount, especially the weight of all monomers (degree of cross-linking) in the inventive material imparting proton conductivity, generally be 0, preferably more than 0 wt %, preferably more than 0 wt % to 15 wt %, preferably more than 0.5 wt % to 15 wt %, particularly preferably 0.50 to 10 wt %, especially 1.0 to 8 wt %.

Within the scope of the present invention, the degree of cross linking in the materials imparting proton conductivity denotes the proportions by weight of the cross-linking monomers (referred to as cross-linking agents with a functionality of >1, preferably >2) relative to the total weight of all monomers.

The advantage of using basic cross-linking agents is that basic centers, which on the one hand facilitate protolysis of the acid electrolyte and on the other hand improve absorption of the electrolyte in the membrane, are formed in the corresponding polymers when they are employed in the phosphoric acid/PBI membrane.

A further positive effect of increasing the number of basic centers is greater absorption of phosphoric acid, in turn leading to more potential charge carriers in the system.

As radical starters for the production of the inventive materials, there can be used common radical starters, such as organic peroxides, especially dicumyl peroxide, tert-butyl cumyl peroxide, bis(tert-butylperoxyisopropyl)benzene, di-tert-butyl peroxide, 2,5-dimethylhexane-2,5-dihydroperoxide, 2,5-dimethylhexyne-3,2,5-dihydroperoxide, dibenzoyl peroxide, bis-(2,4-dichlorobenzoyl) peroxide, tert-butyl perbenzoate, organic azo compounds, especially azobisisobutyronitrile and azobiscyclohexanenitrile. Preferably there are used organic azo compounds, especially azobisisobutyronitrile.

These radical starters may also be used as cross-linking agents (or vulcanization agents) within the meaning of the present application, for subsequent cross-linking after polymerization according to the aforesaid variant b). In this case cross-linking during use of radical starters is brought about by free radicals, which are formed by decomposition of the radical starters. Subsequent cross-linking by means of high-energy radiation is also possible.

According to the invention, cross-linking can be achieved subsequently, after the polymerization, in particular by means of cross-linking agents (vulcanization agents), which are preferably selected from the group comprising organic peroxides, especially dicumyl peroxide, tert-butyl cumyl peroxide, bis(tert-butylperoxyisopropyl)benzene, di-tert-butyl peroxide, 2,5-dimethylhexane-2,5-dihydroperoxide, 2,5-dimethylhexyne-3,2,5-dihydroperoxide, dibenzoyl peroxide, bis-(2,4-dichlorobenzoyl) peroxide, tert-butyl perbenzoate, organic azo compounds, especially azobisisobutyronitrile and azobiscyclohexanenitrile, sulfur-containing cross-linking agents or vulcanization agents, such as dimercapto and polymercapto compounds, especially dimercaptoethane, 1,6-dimercaptohexane, 1,3,5-trimercaptotriazine and mercapto-terminated polysulfide rubbers, such as mercapto-terminated reaction products of bis-chloroethyl formal with sodium polysulfide.

Within the scope of the present invention, it is particularly preferred for the inventive polymeric material to contain monomer units at least on the basis of N-[3-(dimethylamino)propyl]methacrylamide (DMAPMA).

In a particularly preferred embodiment, the monofunctional monomers of the inventive polymeric material consist exclusively of N-[3-(dimethylamino)propyl]methacrylamide (DMAPMA), in addition to cross-linking agents that are preferably present.

Furthermore, it is preferred for the material of the present invention imparting proton conductivity to have monomer units at least on the basis of trimethylolpropane trimethacrylate (TMPTMA) as cross-linking agents.

It is particularly preferred when the material imparting proton conductivity contains monomer units at least on the basis of N-[3-(dimethylamino)propyl]methacrylamide (DMAPMA) and when at least trimethylolpropane trimethacrylate (TMPTMA) is used as cross-linking agent. Particularly preferably, the material imparting proton conductivity consists of these two monomers.

In a further preferred embodiment, the material imparting proton conductivity is subjected after polymerization to cross-linking with sulfur-containing cross-linking or vulcanization agents (sulfur cross-linking), such as to treatment with dimercapto and polymercapto compounds, especially dimercaptoethane, 1,6-dimercaptohexane, 1,3,5-trimercaptotriazine and mercapto-terminated polysulfide rubbers, especially mercapto-terminated reaction products of bis-chloroethyl formal with sodium polysulfide.

The material imparting proton conductivity expediently contains toluene-insoluble fractions (gel content) at 23° C. of generally 50 to 99 wt %, preferably 60 to 90, particularly preferably 63 to 80 wt %.

The gel content was determined by continuous extraction with toluene. For this purpose, a sample amount of approximately 3 g was weighed into a Soxhlet extraction apparatus and extracted for 16 hours under solvent reflux.

The gel content is calculated as follows, as a mass ratio:

$$Gel content = \frac{{m}_{sample after extraction}}{{m}_{sample before extraction}} \cdot 100 \%$$

Furthermore, the inventive material imparting proton conductivity has a mean particle diameter of generally smaller than 50 μm, preferably smaller than 40 μm, particularly preferably smaller than 30 μm, especially smaller than 25 μm. This particle diameter is obtained after polymer production followed by a size-reduction treatment, which will be described hereinafter.

Within the scope of the present invention, the mean particle size is determined by dynamic light scattering. The light-scattering measurements for determination of the particle-size distributions were carried out in the Process Analysis Laboratory (industrial laboratory) of Rhein Chemie Rheinau GmbH as follows.

The Coulter LS 230 light-scattering meter with SVM (small volume modulus) was used for this purpose. For the measurement range from 0.4 to 2000 μm, the LS 230 “light-scattering”particle-size analyzer uses binocular optics. In the Mie scattering range, the PIDS technology (Polarization Intensity Differential Scattering) forms the basis for the measurement, which is carried out with white light at wavelengths of 450, 600 and 900 nm. The light is respectively polarized vertically and horizontally and the scattered light intensity of the perpendicular scattering is recorded at 6 detection angles. The difference of the scattered light intensities corresponding to the different polarization planes yields what is known as the PIDS signal, which depends significantly on particle size. In this way an overall measuring range of 0.04 μm to 2000 μm is made possible without modification of the optics. The 151 detectors consist of circularly disposed segments and achieve measurement in 116 size classes, which are logarithmically distributed and thus represent geometrically similar size classes. Because of the large number of size classes, high resolution of the particle-size distribution is achieved. The measurement range of 0.04 μm to 2000 μm in 116 logarithmically distributed classes is achieved by the series connection of two measuring cells for laser-diffraction measurement and PIDS measurement.

The mean diameter values used according to the invention relate in this case to the weight average (d₅₀).

The polymeric material preferably has a weight-average particle diameter (d₅₀) of smaller than 50 μm.

Since the materials produced according to the invention are produced not by emulsion polymerization but by polymerization in bulk or in solution, followed by size reduction (after previous drying if necessary), they generally exhibit larger mean particle diameters than particles produced by emulsion polymerization. Thus the mean particle diameters of the materials produced according to the invention are generally larger than 700 nm, preferably larger than 800 nm, even more preferably larger than 900 nm and usually larger than 1 μm (1000 nm).

When the inventive materials contain sulfur, especially due to the presence of sulfonic acid groups, it is preferred that the material imparting proton conductivity have a sulfur content of generally 0.5 to 50 wt %, preferably 1 to 40 wt %, especially 2 to 30 wt % relative to the total weight of the said material.

When the inventive materials contain phosphorus, especially due to the presence of phosphorus-containing acid groups, phosphonate groups or phosphate groups, it is preferred that the material imparting proton conductivity have a phosphorus content of generally 0.5 to 50 wt %, preferably 1 to 40 wt %, especially 2 to 30 wt %.

When the inventive materials contain nitrogen, especially due to the presence of amino groups, such as —NR₂ as defined hereinabove, it is preferred that the material imparting proton conductivity have a nitrogen content of generally 0.25 to 30 wt %, preferably 0.6 to 20 wt %, especially 1.0 to 16 wt % relative to the total weight of the said material.

In this connection, the sulfur content, phosphorus content and nitrogen content of the inventive materials correlates with the proportion of sulfur-containing, phosphorus-containing or nitrogen-containing monomers in the polymers.

In a preferred embodiment of the invention, the nitrogen content of the polymeric material used according to the invention is 0.50 to 50 wt % relative to the total weight of the said material.

Furthermore, the inventive material imparting proton conductivity is preferably characterized in that it exhibits a relative weight loss of generally more than 50 wt %, preferably more than 60 wt % up to 430° C. in a thermogravimetric analysis at a heating rate of 10° C./min under a nitrogen atmosphere. Furthermore, it is evident that the inventive material is thermally stable in the planned operating temperature range.

Thermogravimetric analysis shows the change in mass of a sample as a function of temperature and time. For this purpose the sample is placed in a refractory crucible, which can be heated to temperatures of up to 600° C. in an oven. The sample holder is coupled to a microbalance, so that weight changes can be measured during the heating operation. The thermogravimetric analysis indicated according to the invention was performed in a temperature range of 30° C. to 600° C. with a heating rate of 10° C./min under a nitrogen atmosphere.

Furthermore, the inventive material imparting proton conductivity preferably has a storage modulus G′, determined by an oscillating measurement, of generally 100 to 10000 mPa, preferably 300 to 6000 mPa, particularly preferably 600 to 4000 mPa, the said storage modulus being determined as described hereinafter.

Within the scope of the present invention, the storage modulus G′ is determined by oscillating measurement at 30° C. on materials dispersed in N,N-dimethylacetamide/PBI (poly-[2,2′-(m-phenylene)-5,5′-dibenzimidazole]) in the weight ratio of 85.67/14.3/1.43 (N—N-dimethylacetamide/PBI/material imparting proton conductivity). The rheological investigations for this purpose were carried out on the MCR 301 rheometer of Anton Paar Germany GmbH.

A program containing the following sections was used:
Section 1: γ=0.1%, f=1 Hz, T=30° C., 10 measurement points, automatic duration of measurement points for determination of the storage modulus.
Section 2: \dot{γ}=0.1 s⁻¹, T=30° C., 10 measurement points, 5 s duration of measurement points for determination of the dynamic viscosity η at a shear rate \dot{γ}=0.1 s⁻¹.
Section 3: \dot{γ}=0.1 . . . 100 s⁻¹ linearly, T=30° C., 10 measurement points, 2 s duration of measurement points for determination of the dynamic viscosity η at a shear rate \dot{γ}=100 s⁻¹.
Section 4: \dot{γ}=100 s⁻¹, T=30° C., 5 measurement points, 5 s duration of measurement points.

The CP50-1 measuring cone (SN9672) was used with a slit height of 0.05 mm for the measurement.

In a further embodiment of the present invention, the material imparting proton conductivity, dispersed in N,N-dimethylacetamide/PBI (poly-[2,2′-(m-phenylene)-5,5′-dibenzimidazole]) in the weight ratio of 85.67/14.3/1.43 (N—N-dimethylacetamide/PBI/material imparting proton conductivity), exhibits a viscosity η (0.1 s⁻¹) determined by rotating measurement of generally 1000 to 10000 mPa·s, preferably 2000 to 9000 mPa·s, particularly preferably 3500 to 7500 mPa·s at a temperature of 30° C.

In a further embodiment of the present invention, the material imparting proton conductivity, dispersed in N,N-dimethylacetamide/PBI (poly-[2,2′-(m-phenylene)-5,5′-dibenzimidazole]) in the weight ratio of 85.67/14.3/1.43 (N—N-dimethylacetamide/PBI/material imparting proton conductivity), exhibits a viscosity η (100 s⁻¹) determined by rotating measurement of generally 2000 to 8000 mPa·s, preferably 3000 to 6500 mPa·s, particularly preferably 3500 to 5500 mPa·s at a temperature of 30° C.

Furthermore, the inventive material imparting proton conductivity is characterized particularly preferably in that the material has a shear coefficient η (0.1 s⁻¹)/η(100 s⁻¹) (determined, as mentioned in the foregoing, dispersed in N,N-dimethylacetamide/PBI (poly-[2,2′-(m-phenylene)-5,5′-dibenzimidazole]) in the weight ratio of 85.67/14.3/1.43 (N—N-dimethylacetamide/PBI/material imparting proton conductivity) at a temperature of 30° C. of generally 1 to 5, preferably 1 to 3, particularly preferably 1 to 1.8. These measured results (shear coefficients) surprisingly reveal almost Newtonian flow behavior. This proves that the particles have great compatibility with a DMAc-PBI mixture. This proves that the inventive particles have great compatibility with the DMAc-PBI mixture.

The materials imparting proton conductivity and provided according to the invention are preferably obtainable by radical polymerization in bulk or by polymerization in solution.

In a preferred embodiment, the material imparting proton conductivity is produced by a method in which monomers comprising at least one monomer that contains functional groups imparting proton conductivity are polymerized in bulk or in solution, and if necessary the obtained polymeric material is subjected after polymerization to a size-reduction process.

During the radical polymerization in bulk, the undiluted monomer is polymerized thermally, photochemically or after addition of radical-generating agents or radical initiators, and preferably, according to the invention, the addition of radical-generating agents is performed in the manner described in the foregoing. As an example, the amount of the radical-generating agent is 0.01 to 10, especially 0.1 to 4 wt % relative to the total weight of monomers. The polymerization is usually carried out in liquid condition or in the gas phase. In the case of bulk polymerization using pure raw materials, for example, polymers of appropriately high purity are formed, but the reaction is sometimes more difficult to manage, because of the heat of reaction released, the high viscosity of the polymer and its poor thermal conductivity.

Solution polymerization offers better control of the heat removal than does bulk polymerization. The monomers are then polymerized in an inert solvent. The solvent may be chosen such that it boils at the desired polymerization temperature. In this way the liberated heat of polymerization is compensated for by the heat of evaporation. Also, the viscosity may be selected such that the polymer solution can still be stirred at complete conversion.

Suitable solvents for solution polymerization depend on the nature of monomers being reacted and, for example, are selected from water and/or organic solvents. Preferably the solvents have a boiling range of 50 to 150° C., especially 60 to 120° C. Examples of solvents are in particular alcohols, such as methanol, ethanol, n-propanol, isopropanol, n-butanol and isobutanol, preferably isopropanol and/or isobutanol, as well as hydrocarbons, such as toluene, and especially petroleum spirits in the boiling range from 60 to 120° C. It is also possible to use ketones, such as acetone, methyl ethyl ketone, methyl isobutyl ketone, dimethylformamide (DMF), dimethylacetamide (DMAc), N-methylpyrrolidone (NNP), dimethyl sulfoxide (DMSO) and esters, for example ethyl acetate, as well as mixtures thereof. The polymer may precipitate during polymerization or remain in solution. According to the invention, the solvent is preferably separated following polymerization.

After the material imparting proton conductivity has been produced, preferably by polymerization in bulk or by polymerization in solution, the polymeric material obtained is preferably subjected to a size-reduction process.

In the present invention, the nature and procedure of the size-reduction process is not subject to any special limitation and is preferably achieved by grinding, by means of a mill, a bead mill, a triple-roll mill, a dissolver, a vacuum dissolver, an Ultraturrax, a homogenizer and/or a high-pressure homogenizer.

In particular, it is preferred according to the invention that the material imparting proton conductivity, especially if produced by polymerization in bulk or by polymerization in solution, be subjected to an at least two-stage size-reduction process.

According to the invention, the size reduction is preferably carried out, for example, optionally in a first size-reduction step in a mill, wherein the obtained material is preferably subjected to size-reduction in bulk; then a second size reduction is carried out in a second size-reduction step in a dispersing agent, such as in particular an organic solvent, for example with a dissolver, a vacuum dissolver or an Ultraturrax, and, in a third size-reduction step, a dispersion of the inventive material in a dispersing agent is subjected to treatment with a high-pressure homogenizer, a bead mill or a triple-roll mill, particularly preferably a high-pressure homogenizer, which operates, for example, at pressures of greater than 100, preferably greater than 500, more preferably greater than 800 bar. (The cited homogenizer operates at lower pressures than the high-pressure homogenizer, especially at lower than 100 bar).

Grinding (size reduction) of the inventive materials imparting proton conductivity may also be carried out with a rotor and then with a homogenizer several times at slight negative pressure in water or in organic media, for example N,N-dimethylacetamide.

In a preferred embodiment, one or more suitable sieves is used during size reduction for isolation of material having the desired mean particle sizes.

In order to obtain the desired particle sizes defined in the foregoing, it is therefore preferable according to the invention to use, during size reduction, sieves having appropriate mesh openings for isolation of material exhibiting the desired size.

The material imparting proton conductivity is preferably produced by a method in which the material is obtained by radical polymerization of the monomers defined in the foregoing in bulk or in solution, especially followed by size reduction. Preferably the cross-linking agents defined in the foregoing are used. The inventive polymeric material is preferably supplied as dry, preferably finely-divided powder, if necessary after removal of the solvent. However, it may also be supplied in the form of dispersions in solvents such as those mentioned hereinabove.

The materials imparting proton conductivity and used according to the invention may be contained in polymer matrices, such as in the form of molded articles, membranes, films, etc. in a proportion of matrix polymer to polymer particles of 1:99 to 99:1, preferably 10:90 to 90:10, particularly preferably 20:80 to 80:20. The amount of the polymer particles used according to the invention depends on the desired characteristics of the molded articles, for example the proton conductivity of the membranes.

Examples of suitable matrix polymers are thermoplastic polymers, such as standard thermoplastics, so-called techno thermoplastics and so-called high-performance thermoplastics (see H. G. Elias, Macromolecules, Volume 2, 5^{th} Edition, Hüthig & Wepf Verlag, 1991, pages 443 et seq.), for example polypropylene; polyethylene, such as HDPE, LDPE, LLDPE; polystyrene, etc., and polar thermoplastic materials, such as PU, PC, EVM, PVA, PVAC, polyvinyl butyral, PET, PBT, POM, PMMA, PVC, ABS, AES, SAN, PTFE, CTFE, PVF, PVDF, polyvinylimidazole, polyvinylpyridine, polyimides, PA, such as especially PA-6 (nylon), preferably PA-4, PA-66 (perlon), PA-69, PA-610, PA-11, PA-12, PA-612, PA-MXD6, etc., especially (Hüthig & Wepf Verlag, 1991, 431-433, 447) polypropylene; polyethylene, such as HDPE (high-density polyethylene), LDPE (low-density polyethylene), LLDPE (linear low-density polyethylene); polystyrene, etc., and polar thermoplastic materials, such as polyurethanes (PU), polycarbonates (PC), polyethylene terephthalate (PET), polybutylene terephthalate (PBT) or else thermoplastic elastomers, for example based on polyamides (TPE-A), thermoplastic polyurethane elastomers (TPE-U), ethylene-vinyl acetate copolymers (EVM), polyvinyl acetates (PVA/PVAC), polyvinyl butyral, polyethylene terephthalate (PET), polybutylene terephthalate (PBT), polyoxymethylene (POM), polymethyl methacrylate (PMMA), polyvinyl chloride (PVC), acrylonitrile-butadiene-styrene (ABS), polymer of styrene+acrylonitrile in the presence of EPDM elastomers (AES), styrene-acrylonitrile (SAN), polytetrafluoroethylene (PTFE), poly(chlorotrifluoroethylene) (CTFE), polyvinyl fluoride (PVF), polyvinylidene fluoride (PVDF), polyvinylimidazole, polyvinylpyridine, polyimides, polyamides (PA), such as PA-6 (nylon), preferably PA-4, PA-66 (perlon), PA-69, PA-610, PA-11, PA-12, PA-612, PA-MXD6, etc.

The ratio by weight of these matrix polymers to the inventive materials imparting proton conductivity may expediently be from 1:99 to 99:1, preferably 10:90 to 90:10, particularly preferably 20:80 to 80:20. Preferred matrix polymers for application in polyelectrolyte membranes, especially for fuel cells, are polybenzimidazole (for example, U.S. Pat. No. 4,460,763) and alkylated polybenzimidazoles.

The polymeric material used according to the invention is preferably used as an additive for a fuel-cell membrane, especially based on polybenzimidazole (PBI).

The polymeric material used according to the invention is preferably also used as an additive for the production of an electrode of a fuel cell.

The polymeric material used according to the invention is preferably also used as an additive for production of a gas-diffusion electrode of a fuel cell, especially in a catalyst layer of a gas-diffusion electrode.

The inventive materials imparting proton conductivity may be used in particular as an additive in fuel-cell membranes. In contrast to the polybenzimidazole frequently used therein, the inventive material contains flexible polymer chains whose degree of cross-linking is not too high. Protonated basic centers on the inventive material and on the polybenzimidazole repel one another because of their like charges and consequently lead to stretching of the polymer chains. In this way they are able to bind water and phosphoric acid by solvation. Furthermore, the inventive materials lead to a kind of wicking effect in the membranes, thus guiding the liquid, or in other words phosphoric acid, for example, into the absorber. In a manner similar to capillary force, such a wicking effect is greatest when the material to be swollen has high affinity for the swelling liquid, meaning it can be effectively wetted thereby.

The diffusion of water, for example, or more generally of diffusion agents into the polymer is suppressed when the thermodynamic force resulting from the concentration gradient or the potential gradient between the water in the polymer and outside is just as large as the force with which the polymer chains tend to relax from the stretched, ordered arrangement back to a disordered, clustered arrangement. An important mechanism leading to stretching of the polymers and in turn to increase of the volume results from the nature of the ionic functional groups that the inventive material preferably contains. The ions, for example negatively charged carboxylates or sulfonate groups, or positively charged quaternary ammonium groups, that are bound to the polymer chains repel one another because of coulombic interaction and in this way contribute to the stretching of the polymer chains. The stretched polymer chains in turn have a greater solvate volume. For each ion bound to the polymer chain, a counterion, which once again is also strongly solvated, must be present for charge neutrality.

Furthermore, the present invention relates to the use of the polymeric materials imparting proton conductivity for production of gas-diffusion electrodes for polyelectrolyte fuel cells having an operating temperature up to 250° C. and containing several gas-permeable, electrically conductive layers, which comprise at least one gas-diffusion layer and one catalyst layer, wherein the catalyst layer contains the said polymeric material imparting proton conductivity. This catalyst layer contains an electrically conductive support material and an electrocatalyst. The electrically conductive support material of the catalyst layer is preferably selected from the group of metals, metal oxides, metal carbides, carbon materials, such as carbon black, or mixtures thereof. The electrocatalyst is preferably selected from the group of metals and metal alloys, such as metals from the subgroup 6 and/or 8 of the periodic system of the elements, especially platinum and/or ruthenium. The gas-diffusion layer is preferably of carbon material and preferably has the form of paper, fleece, mesh, knitted fabric and/or woven fabric. The catalyst layer preferably contains 0.2 to 50 wt %, particularly preferably 0.5 to 10 wt % of the protonated polymeric material imparting proton conductivity relative to the total mass of the electrically conductive support material and electrocatalyst.

Furthermore, the invention relates to a fuel cell containing the aforesaid polymeric material imparting proton conductivity.

Furthermore, the invention relates in particular to a polymer electrolyte fuel cell containing the aforesaid polymeric material imparting proton conductivity, especially for operation at temperature up to 250° C. with gas-diffusion electrodes having several gas-permeable, electrically conductive layers, which comprise at least one gas-diffusion layer and one catalyst layer, wherein the catalyst layer contains the aforesaid polymeric material imparting proton conductivity, or wherein a membrane used in the fuel cell, especially a PBI membrane, contains the polymeric material imparting proton conductivity. Further membrane materials are: polybenzimidazole (PBI), polypyridine, polypyrimidine, polyimidazole, polybenzthiazole, polybenzoxazole, polyoxadiazole, polyquinoxaline, polythiadiazole, poly(tetrazapyrene) or a combination of two or more thereof, which may be provided with doping agent selected from the group comprising phosphoric acid, phosphoric acid derivatives, phosphonic acid, phosphonic acid derivatives, sulfuric acid, sulfuric acid derivatives, sulfonic acid, sulfonic acid derivatives or a combination of two or more thereof.

The present invention will be explained in more detail on the basis of the following examples, which of course do not limit the present invention.

### EXAMPLES

### 1. Production of Inventive Materials

Inventive materials imparting proton conductivity are produced according to Table 1:

TABLE 1
Production

| | Base modification with | TMPTMA [phm] as cross- |
|---|---|---|
| Sample | DMAPMA [phm*] | linking agent |
| (2) DB 36 | 100 | 0 |
| (3) DB 43 | 96.25 | 3.75 |
| (4) DB 37 | 94 | 6 |

(*phm = parts by weight per 100 parts by weight of monomer).

The homopolymer of sample (2) was produced as follows:

40.00 g (0.235 mol) DMAPMA and 0.386 g (0.705 mmol, 0.3 mol %) of azobisisobutyronitrile initiator (AIBN) were introduced into a three-necked flask purged with nitrogen and heated slowly with stirring under nitrogen. At a bath temperature of 85° C., the AIBN began to dissolve slowly with bubbling and decomposition. At the same time the viscosity increased considerably, and so heating was continued. At a bath temperature of approximately 100° C., the material became firm and to some extent wrapped around the stirrer. At a bath temperature of 170° C., the polymer began to melt and the stirrer became free once again. The reaction was continued for a further three hours in the melt at a bath temperature of 200° C. under nitrogen. After the end of the reaction, the polymer while still hot was poured into a crystallization dish and solidified. After cooling, the material was first subjected to mechanical coarse size reduction and then ground in a ZM100 rotor mill of the Retsch Co. (0.5 mm sieve), incorporated in dimethylacetamide (DMAc) by means of a dissolver and then dispersed four times in DMAc with the APV 1000 homogenizer at 950 bar.

The copolymer of sample (3) was produced as follows:

68.0 g (0.399 mol; 96.25 phm) DMAPMA, 1.28 g (0.0075 mol; 3.75 phm) TMPTMA and 0.210 g (1.28 mmol, 0.3 mol %) AIBN were introduced and made to react by heating the mixture slowly to a temperature of 110° C. in a heating bath under a nitrogen atmosphere. At this temperature a reaction of the AIBN was evident due to bubbling. A powdery mass, which did not melt even at 200° C., was formed. The reaction time at 200° C. was 5 hours. After the end of the reaction, the reaction mixture was treated with methanol in order to wash out the unreacted monomers. Then the residue was dried at 50° C. in vacuum for four hours. The yield was 86.2%.

The copolymer of sample (4) was produced as follows:

65.8 g (0.39 mol; 94 phm) DMAPMA, 4.2 g (0.012 mol; 6 phm) TMPTMA and 0.210 g (1.28 mmol, 0.3 mol %) AIBN were introduced and made to react by heating the mixture slowly to a temperature of 110° C. in a heating bath under a nitrogen atmosphere. At this temperature a reaction of the AIBN was evident due to bubbling. A powdery mass, which did not melt even at 200° C., was formed. The reaction time at 200° C. was 5 hours. After the end of the reaction, the reaction mixture was treated with methanol in order to wash out the unreacted monomers. Then the residue was dried at 50° C. in vacuum for four hours. The yield was 92.6%.

### 2. Light-Scattering Measurement Method

The light-scattering measurements were carried out using the Coulter LS 230 SVM (small volume module) light-scattering meter. The LS 230 SVM has a measurement range from 0.04 to 2000 μm in 160 logarithmically distributed particle-size classes, achieved by the series connection of two measuring cells for laser-diffraction measurement and PIDS measurement. The particle sizes of several polymers, dispersed in N,N-dimethylacetamide/PBI (poly-[2,2′-(m-phenylene)-5,5′-dibenzimidazole]) in the weight ratio of 85.67/14.3/1.43 (N—N-dimethylacetamide/PBI/material imparting proton conductivity), were investigated and compared.

From the light-scattering measurements (weight distribution), the following parameters were selected:
Modality: Number of maxima of the particle-size distribution (M=monomodal, B=bimodal, T=trimodal, Mult=multi-modal)
dₘₑₐₙ: Mean value of the particle-size distribution (mean particle diameter, arithmetic average)
dₘₐₓ: Particle diameter at the maximum of the particle-size distribution (most frequent particle diameter)
d₁₀: Particle diameter at 10 wt % of the particle-size distribution
d₅₀: Particle diameter at 50 wt % of the particle-size distribution (median)
d₉₀: Particle diameter at 90 wt % of the particle-size distribution

Table 2 presents the results from the light-scattering measurements on particles dispersed in N,N-dimethylacetamide/PBI poly-[2,2′-(m-phenylene)-5,5′-dibenzimidazole]). Table 3 lists the gel contents and swelling indices of the investigated materials, determined in toluene, as well as the rheological test results.

TABLE 2
Light-scattering measurements

| | Diameter DMAc/PBI | | | | | |
|---|---|---|---|---|---|---|
| | | dₘₑₐₙ | dₘₐₓ | d₁₀ | d₅₀ | d₉₀ |
| Sample | Modality | [μm] | [μm] | [μm] | [μm] | [μm] |
| DB 36 | mult | 2.5 | 18.9 | 1.9 | 2.7 | 5.0 |
| DB 43 | mult | 2.7 | 17.2 | 1.9 | 3.8 | 5.3 |
| DB 37 | M | 5.6 | 30.1 | 2.6 | 5.5 | 12.4 |

### Explanation:

mult denotes multimodal and M denotes monomodal. These terms relate to the shape of the curve in graphical analysis of the light scattering over a fairly broad range of particle diameters (measurement range from 0.04 μm to 2000 μm).

TABLE 3
Gel contents and swelling indices of the investigated materials, determined in
toluene, as well as the rheological measurements at 30° C. on the
materials dispersed in DMAc/PBI (DMAc:PBI:polymer = 85.67:14.3:1.43)

| | Monomers | | Initiator | | | | Gel | Swelling |
|---|---|---|---|---|---|---|---|---|
| | DMAPMA | TMPTMA | AIBN | G′ | η (0.1 s⁻¹) | Yield | content | index |
| DB | [phm] | [phm] | [mol %] | [mPa] | [mPas] | [%] | [%] | Qi |
| 36 | 100 | 0 | 0.34 | 651 | 4030 | 94.5 | 0 | n.d. |
| 43 | 96.25 | 3.75 | 0.34 | 994 | 4650 | 86.2 | 65.30 | 6.3 |
| 37 | 94 | 6 | 0.33 | 3044 | 6100 | 92.6 | 79.55 | 4.1 |

The gel content was determined by continuous extraction with toluene. For this purpose a sample amount of approximately 3 g was weighed into a Soxhlet extraction apparatus and extracted for 16 hours under solvent reflux.

To obtain a result, the content of the extract was determined by differential weighing.

To determine the swelling index, a polymer sample of approximately 250 mg was swollen in an excess of approximately 1000 times its weight in toluene for 24 hours then filtered off with a fluted filter, weighed, dried to constant weight under vacuum at 70° C. and then weighed once again. The difference between the weights yields the swelling index according to

$${Q}_{i} = \frac{Wet weight}{Dry weight}$$

To check the compatibility, samples 36, 37 and 43 were mixed with dimethylacetamide, dispersed with the high-pressure homogenizer and then mixed with a polybenzimidazole (PBI)/dimethylacetamide solution and stirred. Then a film was cast by means of a 200-mm 4-edge doctor blade. After drying, this had a thickness of 40 μm.

These films were transparent and did not exhibit any cloudiness, thus proving good compatibility.

For the following examples, the membranes were produced by an evaporation method as follows:

To produce a casting solution, samples 36, 37 or 43 as well as 595-7 were mixed with dimethylacetamide, the dimethylacetamide dispersions containing samples 36, 37 or 43 were dispersed with the high-pressure homogenizer and then mixed with a polybenzimidazole (PBI)/dimethylacetamide solution and stirred. This casting solution was then doctored onto a support film and a membrane was produced by evaporation of the solvent under a nitrogen atmosphere.

A polyester film was used as support film for the casting solution. The machine used for this purpose consisted of an unwinding part, a doctor applicator mechanism, an air-flotation dryer and a winding part. The casting solution was filled into the applicator mechanism and applied with a slit height of 250 μm and a doctor width of 28 cm onto the support film. The drawing speed for membrane production was 0.2 m/min. After passing through the inerted dryer (O2 content=6.0%) and over a drying roll with a temperature of 190° C., the membrane was wound with a layer thickness of 30 μm-50 μm onto the polyester film.

For doping, a piece of membrane measuring 136.5 mm×118.5 mm was punched out and its weight determined. The sample was placed between two Teflon gauzes in a Petri dish (d=20 cm) containing approximately 70 mL concentrated phosphoric acid (85%). The sample was maintained for 30 minutes at 130° C. in a circulating-air oven, then removed from the acid, wiped dry with a paper towel and weighed.

Table 4 below shows the results of the membrane tests.

TABLE 4

| | | Swelling in | | σ max [N/mm²], | |
|---|---|---|---|---|---|
| | | 85% H₃PO₄ | | (ε_{σmax} = elongation), | |
| | Composition | [swelling | Extraction | undoped/doped | σ (25° C.) |
| DB | of additive | pressure] | residue [%] | (% H₃PO₄) | [S/m] |
| 595-7 | PBI (100%) | 640 bar | 17 | undoped: 134, (5%) | 3.3 |
| — | | | | doped: 84%: 6.2, | |
| | | | | (59%) | |
| 10% | DMAPMA: | 600 bar | 82 | undoped: 127, (6%) | 5.4 |
| DB36 | 100 | | | doped: 88%: 5.6, | |
| 90% | TMPTMA: 0 | | | (65%) | |
| PBI | | | | | |
| 10% | DMAPMA: | 560 bar | 68 | undoped: 143, (5%) | 4.8 |
| DB43 | 96.25 | | | doped: 85%: 7.5, | |
| 90% | TMPTMA: | | | (82%) | |
| PBI | 3.75 | | | | |
| 10% | DMAPMA: | 520 bar | 63 | undoped: 132, (5%) | 5.0 |
| DB37 | 94 | | | doped: 82%: 8.1, | |
| 90% | TMPTMA: 6 | | | (88%) | |
| PBI | | | | | |

where σ max = breaking tension

The tensile-stress measurements were performed on the Zwick I tensile-stress measuring machine of Zwick GmbH & Co. KG. A 200-N crosshead was used for dry, undoped membranes. For each membrane, pieces of membrane measuring 20 mm×150 mm were punched out, two along, two across and one diagonally relative to the drawing direction of the machine. The thickness of each of the five pieces was measured. Then the samples were clamped and the measurement started. The maximum tensile stress σmax (breaking tension) and the elongation εσmax at the maximum (elongation at break) were determined. The following measurement parameters were adjusted: initial force F=0.5 N, crosshead speed ν=5 mm/min, gauge length=100 mm.

Using a four-contact conductivity-measuring cell, the measurements of conductivity σ were performed by impedance spectroscopy on membranes doped with phosphoric acid and analyzed with the Thales computer program. For this purpose a piece of membrane measuring 2 cm×4.5 cm and doped with phosphoric acid was punched out and its thickness determined. The piece of membrane was installed in an aforesaid conductivity-measuring cell. For measurements at 160° C., the conductivity measuring cell was heated with a heating plate.

A spectrum from 1 MHz to 1 Hz was recorded. At 10 Hz the phase shift was 0°, and the impedance at 10 Hz was read out as the resistance.

The swelling pressure for the swelling process with phosphoric acid was calculated from the relative thickness increase and the relative area increase. Considering the dimensional change for a given phosphoric acid absorption, the following formula is obtained as the calculation basis:

$$Q = \frac{k}{{[ ( 2 {Q}_{F} + {Q}_{D} ) / 300 ]}^{2.327}} [ bar ]$$

where Q_{F} is the dimensional change of area, Q_{D} is the thickness change according to the above equation and k is a constant (679 bar). The swelling pressure describes the pressure with which the polymer network opposes swelling. Thus readily swellable polymers have a low swelling pressure and poorly swellable polymers have a high swelling pressure. In the inventive materials, the swelling pressure, which reflects the elongation of the polymer network, is greatly lowered. This means that the inventive materials favor the absorption of phosphoric acid by the membrane.

In the inventive materials, the extraction residues are distinctly increased, which leads to much more resistant membranes. The added materials therefore act as cross-linking agents.

With increasing content of cross-linking agents in the produced materials, the swelling pressure decreases at 10 percent addition in the membrane; in other words, the swelling due to phosphoric acid increases, the breaking tension and elongation at break of the doped membrane increase, or in other words the mechanical characteristics, the ability to resist extraction and the swelling of the doped membranes were clearly increased by addition of the inventive materials.

The high values of conductivity σ in the conductivity measurements provide impressive proof of the suitability of the membrane material.

SEM photographs of the samples show that the inventive materials exhibit the greatest compatibility with PBI. Table 5 shows an overview of the results.

TABLE 5
Results of the SEM investigations of the membranes.

| | | Nitrogen | | |
|---|---|---|---|---|
| | | content | | |
| DB | Composition | [%] | Appearance | Structure |
| 595-7 | pure PBI | n.d. | clear and | homogeneous |
| — | membrane | | transparent | |
| 614-6 | 100 DMAPMA | 14.38 | clear and | homogeneous |
| 10% DB36 | | | transparent | |
| 614-7 | 94 DMAPMA | 14.36 | clear and | homogeneous |
| 10% DB37 | 6 TMPTMA | | transparent | |
| 614-8 | 96.25 | 15.06 | clear and | homogeneous |
| 10% DB43 | DMAPMA | | transparent | |
| | 3.75 TMPTMA | | | |

Thus the membranes containing the inventive materials can be classified as SEM type P, or in other words as homogeneous.

We claim:

1. The use of polymeric materials imparting proton conductivity, which materials are formed from monomer units and have an irregular form, for the production of fuel cells.

2. The use according to claim 1, wherein the polymeric material is formed from acid-modified and/or base-modified monomer units.

3. The use according to claim 1, wherein the polymeric material has been cross-linked by at least one of the following measures:
a) by copolymerization with multifunctional compounds having cross-linking action (as cross-linking agents),
b) by subsequent cross-linking, after polymerization, using cross-linking agents or by high-energy radiation,
c) by continuing the polymerization to high conversions,
d) in the monomer-feed method, by polymerization with high internal conversions.

4. The use according to claim 1, wherein the polymeric material has been cross-linked by at least one of the following measures:
a) by copolymerization in the melt or in solution with multifunctional compounds having cross-linking action (cross-linking agents),
b) by subsequent cross-linking, after polymerization, using cross-linking agents or by high-energy radiation,
c) by continuing the polymerization in the melt or in solution to high conversions,
d) in the monomer-feed method, by polymerization in the melt or in solution with high internal conversions
then subjecting the polymeric material to at least one size-reduction process after cross-linking.

5. The use according to claim 1, characterized in that the polymeric material is cross-linked with a cross-linking agent.

6. The use according to claim 1, characterized in that the polymeric material comprises monomer units based on at least one compound selected from the group consisting of styrene, ethylene glycol methacrylate phosphate (MAEP), vinylsulfonic acid (VSS), styrenesulfonic acid (SSS), vinylphosphonic acid (VPS), N-vinylimidazole (VID), 4-vinylpyridine (VP), N-[3-(dimethylamino)propyl]methacrylamide (DMAPMA), (dimethylamino)ethyl methacrylate (DMAEMA), acrylamide, 2-acrylamidoglycolic acid, 2-acrylamido-2-methyl-1-propanesulfonic acid, acrylic acid [2-(((butylamino)-carbonyl)-oxy)ethyl ester], acrylic acid (2-diethylaminoethyl ester), acrylic acid (2-dimethylamino)-ethyl ester), acrylic acid (3-dimethylamino)-propyl ester), acrylic acid isopropylamide, acrylic acid phenylamide, acrylic acid (3-sulfopropyl ester) potassium salt, methacrylic acid amide, methacrylic acid 2-aminoethyl ester hydrochloride, methacrylic acid (2-(tert-butylamino)-ethyl ester), methacrylic acid ((2-dimethylamino)-methyl ester), methacrylic acid (3-dimethylaminopropylamide), methacrylic acid isopropylamide, methacrylic acid (3-sulfopropyl ester) potassium salt, 3-vinylaniline, 4-vinylaniline, N-vinylcaprolactam, N-vinylformamide, 1-vinylimidazole, 2-vinylpyridine, 4-vinylpyridine, 1-vinyl-2-pyrrolidone, 5-vinyluracil, methacrylic acid glycidyl ester (GDMA), mixtures of the aforesaid compounds, salts of the aforesaid compounds and the conjugate acids or bases of the aforesaid compounds.

7. The use according to claim 6, characterized in that the proportion by weight of the said monomer units is 0.1 to 100 wt % relative to 100 parts by weight of all monomer units in the polymeric material.

8. The use according to claim 1, characterized in that the polymeric material contains monomer units containing basic and/or acid groups.

9. The use according to claim 1, characterized in that the polymeric material consists of monofunctional monomer units modified by basic and/or acid groups, and possibly of polyfunctional monomer units (cross-linking agents).

10. The use according to claim 1, characterized in that the polymeric material is cross-linked with a neutral or basic cross-linking agent.

11. The use according to claim 1, characterized in that the polymeric material is cross-linked with a cross-linking agent selected from the group consisting of: multifunctional monomers having at least two, preferably 2 to 4 copolymerizable C═C double bonds, diisopropenylbenzene, divinylbenzene, trivinylbenzene, divinyl ether, divinyl sulfone, diallyl phthalate, triallylamine, triallyl cyanurate, triallyl isocyanurate, 1,2-polybutadiene, N,N′-m-phenylene maleimide, 2,4-toluoylenebis(maleimide) and/or triallyl trimellitate, acrylates and methacrylates of polyhydric, preferably dihydric to tetrahydric C2 to C10 alcohols, ethylene glycol, propanediol-1,2, butanediol, hexanediol, polyethylene glycol with 2 to 20, preferably 2 to 8 oxyethylene units, neopentyl glycol, bisphenol A, glycerol, trimethylolpropane, pentaerythritol and sorbitol, trimethylolpropane trimethacrylate (TMPTMA), dimethylene glycol dimethacrylate (EGDMA), unsaturated polyesters of aliphatic diols and polyols and maleic acid, fumaric acid and/or itaconic acid, and polyallylamines.

12. The use according to claim 1, characterized in that the polymeric material is cross-linked by subsequent cross-linking after the polymerization by means of cross-linking agents, wherein the cross-linking agents are selected from the group comprising: as organic peroxides, dicumyl peroxide, tert-butyl cumyl peroxide, bis(tert-butylperoxyisopropyl)benzene, di-tert-butyl peroxide, 2,5-dimethylhexane-2,5-dihydroperoxide, 2,5-dimethylhexyne-3,2,5-dihydroperoxide, dibenzoyl peroxide, bis-(2,4-dichlorobenzoyl) peroxide, tert-butyl perbenzoate, as organic azo compounds, azobisisobutyronitrile and azobiscyclohexanenitrile, as sulfur-containing cross-linking agents, dimercapto and polymercapto compounds, dimercaptoethane, 1,6-dimercaptohexane, 1,3,5-trimercaptotriazine and/or as mercapto-terminated polysulfide rubbers, reaction products of bis-chloroethyl formal with sodium polysulfide.

13. The use according to claim 1, characterized in that the polymeric material is cross-linked with a cross-linking agent, and that the proportion by weight of cross-linking agents relative to the weight of all monomers (degree of cross-linking) in the material is more than 0 wt %, preferably more than 0.5 wt % to 15 wt %.

14. The use according to claim 1, characterized in that the polymeric material contains monomer units at least on the basis of N-[3-(dimethylamino)propyl]methacrylamide (DMAPMA).

15. The use according to claim 1, characterized in that the polymeric material contains monomer units at least on the basis of trimethylolpropane trimethacrylate (TMPTMA) as cross-linking agents.

16. The use according to claim 1, characterized in that the polymeric material contains monomer units at least on the basis of N-[3-(dimethylamino)propyl]methacrylamide (DMAPMA) and trimethylolpropane trimethacrylate (TMPTMA).

17. The use according to claim 1, characterized in that the polymeric material has a gel content of 50 to 99 wt %.

18. The use according to claim 1, characterized in that the polymeric material has a weight-average particle diameter (d₅₀) of smaller than 50 μm.

19. The use according to claim 1, characterized in that the polymeric material has a sulfur content of 0.50 to 50 wt %.

20. The use according to claim 1, characterized in that the polymeric material has a phosphorus content of 0.50 to 50 wt %.

21. The use according to claim 1, characterized in that the polymeric material has a nitrogen content of 0.50 to 50 wt %.

22. The use according to claim 1, characterized in that the polymeric material has a swelling index of 0.5 to 50.

23. The use according to claim 1, characterized in that the polymeric material imparting proton conductivity is produced by a method in which monomers comprising at least one monomer that contains groups imparting proton conductivity are polymerized in bulk or in solution, and if necessary the polymeric material obtained is subjected to a size-reduction process after polymerization.

24. The use according to claim 23, characterized in that the size-reduction process is achieved by grinding, by means of a mill, a bead mill, a triple-roll mill, a dissolver, a vacuum dissolver, an Ultraturrax, a homogenizer and/or a high-pressure homogenizer.

25. The use according to claim 23, characterized in that the material is subjected to an at least two-stage size-reduction process.

26. The use according to claim 23, characterized in that the material, preferably in bulk, is optionally subjected to size reduction in a first size-reduction step in a mill, then, preferably dispersed in a dispersing agent, to size reduction in a second size-reduction step in a dissolver, a vacuum dissolver or an Ultraturrax and/or a bead mill and/or a triple-roll mill, and, in a third size-reduction step, a dispersion of the material, in a dispersing agent is subjected to treatment with a high-pressure homogenizer.

27. The use according to claim 23, characterized in that one or more sieves is used during size reduction for isolation of material having the desired mean particle sizes.

28. The use according to claim 1, characterized in that the polymeric material is used as an additive for a fuel-cell membrane, especially based on polybenzimidazole (PBI).

29. The use according to claim 1, characterized in that the polymeric material is used as an additive for the production of an electrode of a fuel cell.

30. The use according to claim 29, characterized in that the polymeric material is used as an additive for production of a gas-diffusion electrode of a fuel cell, especially in a catalyst layer of a gas-diffusion electrode.

31. Fuel cells containing at least one polymeric material imparting proton conductivity as defined in claim 1.

32. A material for use in the production of a fuel cell, wherein the material is a polymeric material prepared from monomer units, wherein the polymeric material imparts proton conductivity, and wherein the polymeric material has an irregular form.
